(19) United States
(12) Patent Application Publication
(10) Pub. No.: US 2014/0018278 A1
(43) Pub. Date: Jan. 16, 2014

(54) DISHWASHING COMPOSITION WITH IMPROVED PROTECTION AGAINST ALUMINUM CORROSION

(71) Applicants: XINBEI SONG, CINCINNATI, OH (US); JEFFREY SCOTT DUPONT, CINCINNATI, OH (US); PAUL YOURIK, BALTIMORE, MD (US)

(72) Inventors: XINBEI SONG, CINCINNATI, OH (US); JEFFREY SCOTT DUPONT, CINCINNATI, OH (US); PAUL YOURIK, BALTIMORE, MD (US)

(21) Appl. No.: 13/546,306

(22) Filed: Jul. 11, 2012

(51) Int. Cl. C11D 3/60; C11D 17/00

(52) U.S. Cl. 510/224; 510/220; 510/229

(57) ABSTRACT

An automatic dishwashing composition having a preformed polymer with a zinc counterion and an amino acid based builder is useful in the reduction of corrosion in aluminum dishware.

### FIELD

The invention relates to an automatic dishwashing detergent composition.

### BACKGROUND OF THE INVENTION

An important criterion for assessing a dishwashing detergent composition is the appearance of the dishes after washing. A problem which has been in existence for a long time, especially in non-phosphate automatic dishwashing detergents, is the corrosion of aluminum dishware. Corrosion usually manifests itself in the appearance of clouding or streaking, or else by iridescence of the aluminum surface.

Solutions for the reduction of aluminum corrosion, such as the inclusion of zinc and polymers in detergent compositions, have been proposed. However, many automatic dishwashing compositions contain amino acid builders to provide a shine benefit to glassware. These builders have the negative effect of reducing the effectiveness of zinc, thereby requiring elevated levels of zinc in the composition. Without wishing to be bound by theory, these amino acid based builders complex with the zinc before the zinc has a chance to complex with the polymer for transport to the aluminum surface. As a consequence, more zinc must be included in the dishwashing detergent composition to observe a benefit.

Accordingly, there is a need for automatic dishwashing compositions that efficiently provides for the reduction of aluminum corrosion while minimizing the total amount of zinc in the formulation. In addition, there is a need for an automatic dishwashing composition that provides for the reduction of aluminum corrosion while also maintaining the shine of the dishware. Furthermore, there is a need for an automatic dishwashing composition that can be quickly and easily manufactured in unit dose form.

### SUMMARY OF THE INVENTION

An automatic dishwashing detergent composition comprising: a.) from about 5% to about 60% by weight of the composition of an amino acid based builder wherein the amino acid based builder comprises a molecular weight of from about 100 to about 1,000 Da; b.) a preformed polymer having a zinc counterion wherein the preformed polymer is formed by at least the following monomers: a carboxylic acid containing monomer; a sulfonic acid group containing monomer; and optionally further an ionic or nonionogenic monomer; and c.) from about 0.5% to about 10% by weight of the composition of a non-ionic surfactant.

A method of making an automatic dishwashing detergent composition for aluminum protection comprising: mixing zinc sulfate with a polymer to form a preformed polymer with a zinc counterion, wherein the polymer is formed by at least the following monomers: a carboxylic acid containing monomer; a sulfonic acid group containing monomer; and optionally further an ionic or nonionogenic monomer; and adding the preformed polymer with zinc counterion to an amino acid based builder wherein the amino acid based builder comprises a molecular weight of from about 100 to about 1,000 Da.

An automatic dishwashing detergent composition comprising: a.) from about 5% to about 60% by weight of the composition of an amino acid based builder wherein the amino acid based builder comprises a molecular weight of from about 100 to about 1,000 Da; b.) a preformed polymer having a zinc counterion wherein the preformed polymer is formed by at least the following monomers: a carboxylic acid containing monomer; a sulfonic acid group containing monomer; and optionally further an ionic or nonionogenic monomer; and c.) from about 1% to about 20% by weight of the composition of a non-ionic surfactant, wherein the automatic dishwashing detergent composition is contained in a water soluble pouch.

### DETAILED DESCRIPTION OF THE INVENTION

In all embodiments of the invention, all percentages are by weight of the total composition, unless specifically stated otherwise. All ratios are weight ratios, unless specifically stated otherwise. All ranges are inclusive and combinable. The number of significant digits conveys neither a limitation on the indicated amounts nor on the accuracy of the measurements. All numerical amounts are understood to be modified by the word “about” unless otherwise specifically indicated. All such weights as they pertain to listed ingredients are based on the active level and do not include carriers or by-products that may be included in commercially available materials, unless otherwise specified.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Preformed Polymer with Zinc Counterion

Consumers desire a dishwashing detergent composition which does not corrosively change the surface of aluminum dishware. Solutions for the reduction of aluminum corrosion, such as the inclusion of zinc and polymers in detergent compositions, have been proposed. However, such detergent compositions often include amino acid based builders for shine which has a negative impact on the effectiveness of zinc in the detergent. These builders complex with the zinc before the zinc has a chance to complex with the polymer for transport to the aluminum surface. As a consequence, more zinc must be included in the dishwashing detergent composition to observe a benefit.

Surprisingly, it is the combination of a preformed polymer with a zinc counterion that may increase the aluminum corrosion inhibiting effect of the zinc salts and consequently the amount of the zinc salt used can be reduced. As used herein, the term “preformed” refers to a separate entity of polymer and zinc counterion that is created before its subsequent addition to the rest of the detergent composition, especially a detergent composition containing an amino acid based builder.

Without wishing to be bound by theory, zinc is generally not able to combine with the amino acid builder in the wash liquor of an automatic dishwashing machine because the zinc is already complexed with the preformed polymer. Generally these builders are not strong enough to pull the zinc away from the polymer once a preformed polymer has been formed. This allows for a more efficient use of zinc to observe an anti corrosion benefit since there is less zinc lost to the amino acid based builder.

### Zinc Salts

A first aspect of the invention provides for complexing zinc with a polymer to form a preformed polymer with zinc counterion. Thereafter, the preformed polymer can be added to the automatic dishwasher formulation. A variety of zinc salts, both organic and inorganic, can be used to complex with the polymer as described below. The organic zinc salts include, by way of example, one or more zinc salt(s) of at least one monomeric and/or polymeric organic acid wherein the zinc salts of monomeric and/or polymeric organic acids are selected from the group consisting of unbranched saturated or unsaturated monocarboxylic acids, of branched saturated or unsaturated monocarboxylic acids, of saturated and unsaturated dicarboxylic acids, of aromatic mono-, di- and tricarboxylic acids, of sugar acids, of hydroxy acids, of oxo acids, and of amino acids and/or of polymeric carboxylic acids. In one embodiment these preformed polymers with a zinc counterion comprise no magnesium or zinc salts of unbranched or branched, unsaturated or saturated, mono- or polyhydroxylated fatty acids having at least 8 carbon atoms and/or resin acids.

In addition, the zinc salts may be selected from the group consisting of: methanoic acid (formic acid), ethanoic acid (acetic acid), propanoic acid (propionic acid), pentanoic acid (valeric acid), and hexanoic acid (caproic acid).

In one embodiment, the zinc salts are selected from the group of: 2-methylpentanoic acid, 2-ethylhexanoic acid, 2-propylheptanoic acid, 2-butyloctanoic acid, 2-pentylnonanoic acid, and 2-hexyldecanoic acid.

In another embodiment, the zinc salts are selected from the group of unbranched saturated or unsaturated di- or tricarboxylic acids: propanedioic acid (malonic acid), butanedioic acid (succinic acid), pentanedioic acid (glutaric acid), hexanedioic acid (adipic acid), and heptanedioic acid (pimelic acid).

In a further embodiment, from the group of aromatic mono-, di- and tricarboxylic acids: benzoic acid, 2-carboxybenzoic acid (phthalic acid), 3-carboxybenzoic acid (isophthalic acid), 4-carboxybenzoic acid (terephthalic acid), 3,4-dicarboxybenzoic acid (trimellitic acid), 3,5-dicarboxybenzoic acid (trimesionic acid).

Zinc salts may also be selected from the group of sugar acids: galactonic acid, mannonic acid, fructonic acid, arabinonic acid, xylonic acid, ribonic acid, 2-deoxyribonic acid, alginic acid.

Zinc salts may also be selected from the group of hydroxy acids: hydroxyphenylacetic acid (mandelic acid), 2-hydroxypropionic acid (lactic acid), hydroxysuccinic acid (malic acid), 2,3-dihydroxybutanedioic acid (tartaric acid), 2-hydroxy-1,2,3-propanetricarboxylic acid (citric acid), ascorbic acid, 2-hydroxybenzoic acid (salicylic acid), 3,4,5-trihydroxybenzoic acid (gallic acid).

Zinc salts may also be selected from the group of oxo acids: 2-oxopropionic acid (pyruvic acid), 4-oxopentanoic acid (levulinic acid).

Zinc salts may also be selected from the group of amino acids: alanine, valine, leucine, isoleucine, proline, tryptophan, phenylalanine, methionine, glycine, serine, tyrosine, threonine, cysteine, asparagine, glutamine, aspartic acid, glutamic acid, lysine, arginine, histidine.

In a further embodiment of the present invention, the preformed polymer comprises at least one zinc salt of an organic carboxylic acid, in one embodiment a zinc salt from the group consisting of zinc stearate, zinc oleate, zinc gluconate, zinc acetate, zinc lactate and/or zinc citrate.

The spectrum of the zinc salts, in one embodiment of organic carboxylic acids, ranges from salts which are sparingly soluble or insoluble in water, i.e. have a solubility below 100 mg/l, in one embodiment below 10 mg/l, in particular no solubility, to those salts which have a solubility in water above 100 mg/l, in one embodiment above 500 mg/l, in another embodiment above 1 g/l and in another embodiment above 5 g/l (all solubilities at 20° C. water temperature).

The first group of zinc salts includes, for example, zinc citrate, zinc oleate and zinc stearate, and the group of soluble zinc salts includes, for example, zinc formate, zinc acetate, zinc lactate and zinc gluconate. In one embodiment, the zinc salt is zinc sulfate.

Inorganic zinc salts may also be used as a counterion to the preformed polymer with zinc counterion. The inorganic zinc salts include, by way of example, one or more zinc salt(s) in one of the oxidation states II, III, IV, V or VI. In one aspect, suitable metal salts and/or metal complexes may be chosen from the group consisting of Zn(II) sulphate, Zn(II) citrate, Zn(II) stearate, Zn(II) acetylacetonate, Zn(II) nitrate, hydrozincite, zinc chloride, zinc bromide, or zinc acetate.

Further suitable inorganic zinc salts are disclosed in WO 94/26860 and WO 94/26859.

### Preformed Zinc Counterion Polymer

A variety of polymers may be used to complex with zinc to form a preformed polymer with zinc counterion. In one embodiment, the polymer is formed by at least the following monomers: (i) a carboxylic acid containing monomer; (ii) a sulfonic acid group containing monomer; and (iii) optionally further an ionic or nonionogenic monomer.

Suitable preformed polymers with sulfonated/carboxylated monomers described herein may have a weight average molecular weight of less than or equal to about 100,000 Da, or less than or equal to about 75,000 Da, or less than or equal to about 50,000 Da, or from about 3,000 Da to about 50,000, in another embodiment from about 4,500 Da to about 20,000 Da, in another embodiment from about 8,000 Da to about 10,000 Da.

In one embodiment, the preformed polymer is selected to have one or more copolymers of unsaturated or saturated carboxylic acid monomers. Carboxylic acid monomers include one or more of the following: acrylic acid, maleic acid, itaconic acid, methacrylic acid, or ethoxylate esters of acrylic acids, acrylic and methacrylic acids. In one embodiment, the carboxylic acid is (meth)acrylic acid.

In another embodiment, the preformed polymer is selected to have one or more monomers containing sulfonic acid groups. Sulfonated monomers include one or more of the following: sodium (meth)allyl sulfonate, vinyl sulfonate, sodium phenyl (meth)allyl ether sulfonate, or 2-acrylamido-methyl propane sulfonic acid. In one embodiment, the unsaturated sulfonic acid monomer is most 2-acrylamido-2-propanesulfonic acid (AMPS).

In a further embodiment, the preformed polymer is selected to include ionic or nonionogenic monomers. Non-ionic monomers include one or more of the following: methyl (meth)acrylate, ethyl (meth)acrylate, t-butyl (meth)acrylate, methyl (meth)acrylamide, ethyl (meth)acrylamide, t-butyl (meth)acrylamide, styrene, or α-methyl styrene.

In one embodiment, the preformed polymer comprises the following levels of monomers: from about 40 to about 90%, in another embodiment from about 60 to about 90% by weight of the polymer of one or more carboxylic acid monomer; from about 5 to about 50%, in another embodiment from about 10 to about 40% by weight of the polymer of one or more sulfonic acid monomer; and optionally from about 1% to about 30%, in one embodiment from about 2 to about 20% by weight of the polymer of one or more non-ionic monomer. In one embodiment the polymer comprises about 70% to about 80% by weight of the polymer of at least one carboxylic acid monomer and from about 20% to about 30% by weight of the polymer of at least one sulfonic acid monomer.

Examples of commercial available polymers include: Acusol 587G and Acusol 588G supplied by Dow (formerly Rohm & Haas) and those described in U.S. Pat. No. 5,308,532 and in WO 2005/090541. Acusol 588 is a polymer comprising about 65 weight percent of acrylic acid and about 35 weight percent of 2-acrylamido-2-methylpropane sulfonic acid (AMPS).

In another embodiment, the preformed polymers are GT-101 which is a polymer comprising about 31 weight percent of acrylic acid; 53 weight percent of maleic acid; and 16 weight percent of 3-allyloxy-2-hydroxy-1-propanesulfonate (HAPS). GT101 is sourced from Nippon Shokubai.

The polymers are preformed with a zinc counterion. The polymers may also be added individually to the detergent composition in addition to the preformed polymer with a zinc counterion.

The preformed polymer with a zinc counterion can be formed from any method that combines zinc salt with a polymer before addition to the automatic dishwashing detergent composition containing a builder. In one embodiment, the method of making an automatic dishwashing detergent composition for aluminum protection comprises mixing zinc salt (e.g. zinc sulfate) with a polymer in acid form. The zinc replaces the hydrogen (H) group on the polymer in acid form to form a preformed polymer with zinc counterion. The preformed polymer with zinc counterion is then added to a detergent composition containing an amino acid based builder wherein the amino acid based builder comprises a molecular weight of from about 100 to about 1,000 Da.

In one embodiment, the compositions of the present invention can contain one, two, three of more different preformed polymers. In another embodiment, the compositions of the present invention can contain one, two, three of more different preformed polymer as well as one, two, three or more non-preformed polymers.

In another embodiment, the method of making an automatic dishwashing detergent composition for aluminum protection comprises mixing zinc salt (e.g. zinc sulfate) with a sodium salt of a polymer (O⁻Na⁺) to facilitate a counterion exchange. The zinc replaces the Na⁺ to form a (O⁻Zn) group on the polymer. The preformed polymer with zinc counterion is then added to a detergent composition containing an amino acid based builder wherein the amino acid based builder comprises a molecular weight of from about 100 to about 1,000 Da.

In one embodiment, the molar ratio of zinc to polymer in the preformed polymer with zinc counterion is from about 0.1 to about 100:1; in another embodiment from about 0.5:1 to about 50:1; and in another embodiment from about 1:1 to about 10:1.

Once added to the automatic dishwashing detergent composition, the preformed polymer with zinc counterion may be present in the automatic dishwashing detergent composition in an amount from about 0.5% to about 50%, in another embodiment from about 5% to about 35%, in another embodiment from about 5% to about 15% by weight of the total composition. A complete description of polymers that may be suitable for use herein can be found in U.S. 2011/000903, pages 2, line 4 to page 8, line 25, and in U.S. Pat. No. 7,892,362, column 6, line 35 to column 17, line 25.

### Cleaning Actives

Any traditional cleaning ingredients can be used as part of the automatic dishwashing detergent composition. The levels given are weight percent and refer to the total composition (excluding the enveloping water-soluble material). The cleaning product can contain a phosphate builder or be free of phosphate builder and comprise one or more detergent active components which may be selected from surfactants, alkalinity sources, enzymes, polymers, anti-corrosion agents (e.g. sodium silicate) and care agents. In one embodiment, the automatic dishwashing detergent composition includes a builder compound, an alkalinity source, a surfactant, an anti-scaling polymer (in one embodiment a sulfonated polymer), an enzyme, and an additional bleaching agent.

### Builder

Builders for use herein include amino acid based builders. Builders are used in a level of from about 1% to about 60%, in another embodiment from about 5% to about 50%, in another embodiment from about 15% to about 30% by weight of the composition.

Amino acid based builders include MGDA (methyl-glycine-diacetic acid), and salts and derivatives thereof and GLDA (glutamic-N,N-diacetic acid) and salts and derivatives thereof. GLDA (salts and derivatives thereof) is included in one embodiment, more specifically the tetrasodium salt. In one embodiment, the composition is substantially free of phosphate builders. Other suitable builders are described in U.S. Pat. No. 6,426,229.

### Surfactant

The dishwashing detergent composition may comprise a non-ionic surfactant or a non-ionic surfactant system. In one embodiment, the non-ionic surfactant or the non-ionic surfactant system has a phase inversion temperature, as measured at a concentration of 1% in distilled water, of between 40 and 70° C., in another embodiment between 45 and 65° C. By a “non-ionic surfactant system” is meant herein a mixture of two or more non-ionic surfactants. In one embodiment, the automatic dishwashing detergent composition is substantially free of anionic and/or zwitterionic surfactants.

Surfactants may be present in amounts from 0 to 10% by weight, in another embodiment from 0.1% to 10%, in another embodiment from about 1% to about 8%, and another embodiment from 0.25% to 6% by weight of the total composition. In one embodiment, the product of the invention comprises from 0.1 to 10% of non-ionic surfactant wherein at least 50%, in another embodiment at least 60% of the total amount of non-ionic surfactant is in an aqueous composition or an aqueous composition component of a unit dose form.

Suitable nonionic surfactants include: i) ethoxylated non-ionic surfactants prepared by the reaction of a monohydroxy alkanol or alkyphenol with 6 to 20 carbon atoms with at least 12 moles, in another embodiment at least 16 moles, and in another embodiment at least 20 moles of ethylene oxide per mole of alcohol or alkylphenol; ii) alcohol alkoxylated surfactants having a from 6 to 20 carbon atoms and at least one ethoxy and propoxy group. In one embodiment are mixtures of surfactants i) and ii).

### Silicates

Silicates, if present, are at a level of from about 1 to about 20%, in one embodiment from about 5 to about 15% by weight of the composition. In one embodiment, silicates are sodium silicates such as sodium disilicate, sodium metasilicate and crystalline phyllosilicates.

### Enzyme

Suitable enzymes for use in the automatic dishwashing detergent composition include proteases such as metalloproteases and serine proteases. Suitable proteases include those of animal, vegetable or microbial origin. Chemically or genetically modified mutants are included.

Commerically available protease enzymes include those sold under the trade names Alcalase®, Savinase®, Primase®, Durazym®, Polarzyme®, Kannase®, Liquanase®, Ovozyme®, Neutrase®, Everlase® and Esperase® by Novo Nordisk A/S (Denmark), those sold under the tradename Maxatase®, Maxacal®, Maxapem®, Properase®, Purafect®, Purafect Prime®, Purafect Ox®, FN3®, FN4®, Purafect OXP® and Excellase® by Genencor International, and those sold under the tradename Opticlean® and Optimase® by Solvay

In one embodiment, the cleaning composition of the invention comprises at least 0.001 mg of active protease. In further embodiments, the composition comprises a high level of protease, in particular at least 0.1 mg of active protease per gram of composition. In one embodiment, levels of protease in the compositions of the invention include from about 1.5 to about 10, in another embodiment from about 1.8 to about 5, and in another embodiment from about 2 to about 4 mg of active protease per gram of composition.

In another embodiment, the enzyme is an amylase. Suitable alpha-amylases include those of bacterial or fungal origin. Chemically or genetically modified mutants (variants) are included.

Suitable commercially available alpha-amylases are DURAMYL®, LIQUEZYME®TERMAMYL®, TERMAMYL ULTRA®, NATALASE®, SUPRAMYL®, STAINZYME®, STAINZYME PLUS®, FUNGAMYL® and BAN® (Novozymes A/S), BIOAMYLASE-D(G), BIOAMYLASE® L (Biocon India Ltd.), KEMZYM® AT 9000 (Biozym Ges. m.b.H, Austria), RAPIDASE®, PURASTAR®, OPTISIZE HT PLUS® and PURASTAR OXAM® (Genencor International Inc.) and KAM® (KAO, Japan). In one embodiment, amylases are NATALASE®, STAINZYME® and STAINZYME PLUS® and mixtures thereof.

In one embodiment, the composition comprises at least 0.001 mg of active amylase. In one embodiment high level of amylase is used, at least 0.05 mg of active amylase per gram of composition, in another embodiment from about 0.1 to about 10, in another embodiment from about 0.25 to about 6, in another embodiment from about 0.3 to about 4 mg of active amylase per gram of composition. A complete description of enzymes suitable for use herein can be found in U.S. Pat. No. 7,892,362, column 6, line 35 to column 17, line 25.

### Bleach

Inorganic and organic bleaches are suitable cleaning actives for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated.

Alkali metal percarbonates, particularly sodium percarbonate are perhydrates for use herein. The percarbonate may be incorporated into the products in a coated form which provides in-product stability. A suitable coating material providing in product stability comprises mixed salt of a water-soluble alkali metal sulphate and carbonate. Such coatings together with coating processes have previously been described in GB-1,466,799. The weight ratio of the mixed salt coating material to percarbonate lies in the range from 1:200 to 1:4, in another embodiment from 1:99 to 1 9, and in another embodiment from 1:49 to 1:19. In one embodiment, the mixed salt is of sodium sulphate and sodium carbonate which has the general formula Na₂SO₄.n.Na₂CO₃ wherein n is from 0.1 to 3, in one embodiment n is from 0.3 to 1.0 and in another embodiment n is from 0.2 to 0.5.

Another suitable coating material providing product stability comprises sodium silicate of SiO2:Na₂O ratio from 1.8:1 to 3.0:1, in another embodiment L8:1 to 2.4:1, and/or sodium metasilicate, applied at a level of from 2% to 10%, (normally from 3% to 5%) of SiO₂ by weight of the inorganic perhydrate salt. Magnesium silicate can also be included in the coating. Coatings that contain silicate and borate salts or boric acids or other inorganics are also suitable. Other coatings which contain waxes, oils, fatty soaps can also be used advantageously within the present invention. Potassium peroxymonopersulfate is another inorganic perhydrate salt of utility herein.

Typical organic bleaches are organic peroxyacids including diacyl and tetraacylperoxides, especially diperoxydodecanedioc acid, diperoxytetradecanedioc acid, and diperoxyhexadecanedioc acid. In one embodiment, dibenzoyl peroxide is an organic peroxyacid herein.

The diacyl peroxide, especially dibenzoyl peroxide, should be present in the form of particles having a weight average diameter of from about 0.1 to about 100 microns, in another embodiment from about 0.5 to about 30 microns, and in another embodiment from about 1 to about 10 microns. In one embodiment, at least about 25% of the particles are smaller than 10 microns, in another embodiment at least about 50%, in another embodiment at least about 75%, and in another embodiment at least about 90%. Diacyl peroxides within the above particle size range have also been found to provide better stain removal especially from plastic dishware, while minimizing undesirable deposition and filming during use in automatic dishwashing machines, than larger diacyl peroxide particles. The diacyl peroxide particle size thus allows the formulator to obtain good stain removal with a low level of diacyl peroxide, which reduces deposition and filming. Conversely, as diacyl peroxide particle size increases, more diacyl peroxide is needed for good stain removal, which increases deposition on surfaces encountered during the dishwashing process.

Further typical organic bleaches include the peroxy acids, particular examples being the alkylperoxy acids and the arylperoxy acids. Representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, E-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

In one embodiment, the composition of the invention contains percarbonate. In another embodiment, the composition comprises sodium percarbonate.

### Bleach Activators

Bleach activators are typically organic peracid precursors that enhance the bleaching action in the course of cleaning at temperatures of 60° C. and below. Bleach activators suitable for use herein include compounds which, under perhydrolysis conditions, give aliphatic peroxoycarboxylic acids having preferably from 1 to 10 carbon atoms, in particular from 2 to 4 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). Bleach activators if included in the compositions of the invention are in a level of from about 0.1 to about 10%, preferably from about 0.5 to about 2% by weight of the composition.

### Bleach Catalyst

Bleach catalysts preferred for use herein include the manganese triazacyclononane and related complexes (U.S. Pat. No. 4,246,612, U.S. Pat. No. 5,227,084); Co, Cu, Mn and Fe bispyridylamine and related complexes (U.S. Pat. No. 5,114,611); and pentamine acetate cobalt(III) and related complexes (U.S. Pat. No. 4,810,410). A complete description of bleach catalysts suitable for use herein can be found in WO 99/06521, pages 34, line 26 to page 40, line 16. Bleach catalyst if included in the compositions of the invention are in a level of from about 0.1 to about 10%, preferably from about 0.5 to about 2% by weight of the composition.

### Alkalinity

Examples of alkalinity source include, but are not limited to, an alkali hydroxide, alkali hydride, alkali oxide, alkali sesquicarbonate, alkali carbonate, alkali borate, alkali salt of mineral acid, alkali amine, alkaloid and mixtures thereof. In one embodiment, the alkalinity source is sodium carbonate, in another embodiment sodium hydroxide, in another embodiment potassium hydroxide. The alkalinity source is typically present in an amount sufficient to give the wash liquor a pH of from about 8 to about 12, more preferably from about 9 to about 11.5. The composition herein may comprise from about 1% to about 40%, more preferably from about 2% to 20% by weight of the composition of alkaline source.

The wash liquor comprises an alkalinity source in an amount sufficient to give the wash liquor the desired pH. In one embodiment the wash liquor contains from about 20 to about 1,200 ppm, in another embodiment from about 100 to about 1,000 of an alkalinity source. In one embodiment the alkalinity source comprises a source of univalent ions. Univalent ions contribute to high alkalinity and at the same time hardly raise the ionic strength of the wash solution. Preferred alkalinity sources for use herein are metal hydroxides, in particular sodium or potassium hydroxide and potassium hydroxide.

### Water-Soluble Pouch

In one embodiment, the product of the invention is a unit-dose product. Products in unit dose form include tablets, capsules, sachets, pouches, etc. In one embodiment, the unit dose is contained in a water-soluble film (including tablets, capsules, sachets, pouches). In one embodiment, the product is in the form of a water soluble pouch. A non-limiting example of a pouch material includes polyvinyl alcohol.

In one embodiment, the composition of the invention is contained in a water-soluble film pouch or a water soluble injection molded pouch. Examples of injection molded pouches can be found in U.S. 2011/0175257. The weight of the composition of the invention contained in the pouch (excluding the weight of the pouch material) is from about 10 to about 35 grams, in one embodiment from about 12 to about 26 grams, and in another embodiment from 14 to 22 grams. This weight is inclusive of the composition contained in one or more compartments of the unit dose form, alternatively the composition divided into one or more components wherein the components are contained in one or more compartments of the unit dose form.

In one embodiment, the pouches comprise one compartment, alternatively two, or three or more compartments. In another embodiment, the pouches comprise at least two side-by-side compartments to form multi-compartment pouches. In one embodiment, the two compartments are superposed to one another. The compartments may contain components of the overall claimed composition described herein. Examples of multi-compartment pouches and the methods of making them can be found in U.S. Pat. No. 7,125,828.

In one embodiment, at least one of the compartments contains a powder component and the other compartment contains a non-powder component. Non-powder components can be in the form of a gel or a liquid or an aqueous liquid. The powder component can be compressed powder or non-compressed powder or mixtures thereof. In one embodiment, at least one of the compartments contains a solid component and another compartment contains a non-solid component. In another embodiment, at least one of the compartments contains a solid component and another compartment contains an aqueous liquid component. The components contained in the respective compartments can have the same or varying weight ratios to each other.

In one embodiment, two side-by-side compartments each contain liquid compositions. In another embodiment, each compartment if the multi-compartment pouches contain different compositions, and at least one compartment contains a solid composition. In one embodiment the solid composition is in powder form, specifically a densified powder. The solid composition contributes to the strength and robustness of the pack. In one embodiment, at least one compartment contains a multiphase composition.

In one embodiment, the pouch has an overall volume of from about 5 to about 70 ml, in another embodiment from about 15 to about 60 ml, in another embodiment from about 18 to 57 ml. The pouch may have a longitudinal/transverse aspect ratio in the range from about 2:1 to about 1:8, in another embodiment from about 1:1 to about 1:4. The longitudinal dimension is defined as the maximum height of the pouch when the pouch is lying on one of the bases which has the maximum footprint with the pouch compartments superposed in a longitudinal direction, i.e. one over another, and under a static load of about 2 Kg. The transverse dimension is defined as the maximum width of the pouch in a plane perpendicular to the longitudinal direction under the same conditions. These dimensions are adequate to fit the dispensers of the majority of dishwashers. Although the shape of the pouch can vary widely, in order to maximize the available volume, pouches should have a base as similar as possible to the footprint of the majority of the dispensers, that is generally rectangular.

The enzymes can lose stability in the composition due to their interactions with bleach and builders (they can destabilize the enzyme by binding to the calcium of the enzymes). In addition, the performance of enzymes in a composition can be impaired by the alkalinity of the solution, bleach, builders, etc. In one embodiment, the solid composition of the multi-compartment pouch comprises bleach and the liquid composition comprises enzymes. In one embodiment one of the films enclosing the enzyme-comprising composition dissolves prior to the films enclosing the bleach-containing composition during the main-wash cycle of the automatic dishwashing machine, thereby releasing the enzyme-containing composition into the wash liquor prior to the delivery of the bleach-containing composition. This gives the enzymes the possibility to operate under optimum conditions, avoiding interactions with other detergent actives.

Controlled release of the ingredients of the multi-compartment pouch can be achieved by modifying the thickness of the film and/or the solubility of the film material. The solubility of the film material can be delayed by, for example, cross-linking the film as described in WO 02/102,955 at pages 17 and 18. Other water-soluble films designed for rinse release are described in U.S. Pat. No. 4,765,916 and U.S. Pat. No. 4,972,017.

Other means of obtaining delayed release by multi-compartment pouches with different compartments, where the compartments are made of films having different solubility are taught in WO 02/08380.

### EXAMPLES

### Example 1

### Automatic Dishwasher Detergents

| | A (wt %) | B (wt %) | C (wt %) |
|---|---|---|---|
| Sodium Carbonate | 5-10 | | 30-40 |
| Sodium Bicarbonate | | 15-25 | |
| Sodium Silicate | 10-12 | 1-3 | 0.5-2 |
| MGDA | 1-7 | | 1-7 |
| GLDA | | 1-7 | |
| Nonionic surfactant¹ | | 1-2 | 0.5-2 |
| Polymer dispersant² | 3-5 | | |
| Polymer with Zinc Ion³ | 0.5-2 | 1-3 | 1-5 |
| Enzymes | | 0.1-1 | 0.1-1 |
| Bleach, bleach catalyst, | 0.5-2 | | |
| bleach activitor | | | |
| Sodium Hypochloride | 0.5-1.5 | | |
| Sodium Sulfate | 2-5 | 2-5 | 20-60 |
| Sodium Benzoate | 0.5-1.5 | 0.5-1.5 | |
| Perfume | 0.01-0.1 | 0.01-0.1 | 0.01-0.1 |
| Xanthan gum | | 0.5-1.5 | |
| Polygel DKP | 1-2 | | |
| Water, dye and other | Balance to | Balance to | Balance to |
| adjuncts | 100 wt % | 100 wt % | 100 wt % |

¹SLF-18 POLY TERGENT from the BASF Corporation.
²Copolymer ACUSOL ® 425N from Dow.
³Polymer with Zinc Counterion

It is to be understood that a polymer or mixture of polymers as defined in the Polymer section may be substituted with an equivalent amount in Example 1 or 2.

### Example 2

### Automatic Dishwashing Unit-Dose Products

| Example | A |
|---|---|
| Particulate composition | |
| STPP | 0 |
| Silicate | 1-5 |
| Sodium Carbonate | 25-50 |
| MGDA | 5-25 |
| Polymers with Zinc Ion¹ | 5-10 |
| Polymer Dispersant² | 0-5 |
| Nonionic Surfactant³ | 3-10 |
| Enzyme | 1-6 |
| Bleach, Bleach Catalyst, Activator | 5-15 |
| Perfume | 0.05-0.2 |
| Sodium Sulfate | 0-20 |
| Liquid composition | |
| DPG | 40-50 |
| Nonionic Surfactant³ | 40-50 |
| Neodol C11E9 | 0-5.0 |
| Glycerine | 0-5.0 |
| Dye | 0.1-1.0 |

¹A copolymer or any mixture of copolymers with zinc ions defined in the Polymer Section
²ACUSOL ® 445N from Dow
³SLF-18 POLY TERGENT from the BASF Corporation.

As used herein, the article “a” means at least one or one or more, unless it is specifically defined to mean otherwise. All numerical quantities are understood to be modified by the word “about,” unless specifically noted otherwise or unless an exact amount is needed to define the invention over the prior art.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. An automatic dishwashing detergent composition comprising:
a.) from about 5% to about 60% by weight of the composition of an amino acid based builder wherein the amino acid based builder comprises a molecular weight of from about 100 to about 1,000 Da;
b.) a preformed polymer having a zinc counterion wherein the preformed polymer is formed by at least the following monomers:
i.) a carboxylic acid containing monomer;
ii.) a sulfonic acid group containing monomer; and
iii.) optionally further an ionic or nonionogenic monomer; and
c.) from about 0.5% to about 10% by weight of the composition of a non-ionic surfactant.

2. The automatic dishwashing composition of claim 1, wherein the amino acid based builder is present from about 10% to about 50% by weight of the composition.

3. The automatic dishwashing composition of claim 2, wherein the amino acid based builder is present from about 15% to about 30% by weight of the composition.

4. The automatic dishwashing composition of claim 3, wherein the amino acid based builder is selected from the group consisting of methyl-glycine-diacetic acid and salts thereof, glutamic-N,N-diacetic acid and salts thereof, and mixtures thereof.

5. The automatic dishwashing composition of claim 4, wherein the zinc counterion is a zinc salt, and wherein the zinc salt is zinc sulfate.

6. The automatic dishwashing composition of claim 5, wherein the molar ratio of zinc salt to polymer in the preformed polymer is from about 0.1:1 to about 100:1.

7. The automatic dishwashing composition of claim 6, wherein the molar ratio of zinc salt to polymer in the preformed polymer is from about 1:1 to about 10:1.

8. The automatic dishwashing composition of claim 7, wherein the preformed polymer with a zinc counterion is present in the composition from about 0.1% to about 50% by weight of the composition.

9. The automatic dishwashing composition of claim 8, wherein the non-ionic surfactant is present in the composition from about 1% to about 8% by weight of the composition.

10. The automatic dishwashing composition of claim 9, wherein the composition is substantially free of anionic, zwitterionic, and amphoteric surfactants.

11. The automatic dishwashing composition of claim 10, wherein the composition is free of phosphate.

12. The automatic dishwashing composition of claim 11, further comprising an enzyme, wherein the enzyme is selected from the group consisting of proteases, amylases, and mixtures thereof.

13. The automatic dishwashing composition of claim 12, wherein the enzyme is present in the composition from about 0.001 mg to about 10 mg.

14. The automatic dishwashing composition of claim 13, further comprising a source of alkalinity wherein the source of alkalinity is sodium carbonate or potassium carbonate and wherein the source of alkalinity is present from about 2% to about 30% by weight of the composition.

15. The automatic dishwashing composition of claim 14, further comprising from about 5% to about 20% by weight of the composition of sodium carbonate or potassium carbonate.

16. A method of making an automatic dishwashing detergent composition for aluminum protection comprising:
a.) mixing zinc sulfate with a polymer to form a preformed polymer with a zinc counterion, wherein the polymer is formed by at least the following monomers:
iv.) a carboxylic acid containing monomer;
v.) a sulfonic acid group containing monomer; and
vi.) optionally further an ionic or nonionogenic monomer; and
b.) adding the preformed polymer with zinc counterion to an amino acid based builder wherein the amino acid based builder comprises a molecular weight of from about 1,000 to about 20,000 Da.

17. The method of making an automatic dishwashing detergent composition of claim 16, wherein the molar ratio of zinc salt to polymer in the preformed polymer is from about 0.1:1 to about 100:1.

18. An automatic dishwashing detergent unit dose product comprising:
A. detergent composition comprising:
a.) from about 5% to about 60% by weight of the composition of an amino acid based builder wherein the amino acid based builder comprises a molecular weight of from about 1 100 to about 1,000 Da;
b.) a preformed polymer having a zinc counterion wherein the preformed polymer is formed by at least the following monomers:
vii.) a carboxylic acid containing monomer;
viii.) a sulfonic acid group containing monomer; and
ix.) optionally further an ionic or nonionogenic monomer; and
c.) from about 1% to about 20% by weight of the composition of a non-ionic surfactant;
B. water soluble pouch, wherein the detergent composition is contained in a water soluble pouch.

19. The automatic dishwashing composition of claim 16, wherein the water soluble pouch has multiple compartments wherein at least one of the compartments comprises an enzyme and wherein at least another compartment comprises bleach.

20. The automatic dishwashing composition of claim 17, wherein at least one of the compartments contains at least a component of the composition in powder form and wherein the powder form comprises a bleach.
